(19) United States
(12) Patent Application Publication
(10) Pub. No.: US 2026/0112901 A1
(43) Pub. Date: Apr. 23, 2026

(54) ELECTRICITY STORAGE APPARATUS

(71) Applicant: Prime Planet Energy & Solutions, Inc., Tokyo (JP)

(72) Inventors: Masayuki OTSUKA, Kasai-shi (JP); Katsuhiro ARINOBU, Takasago-shi (JP); Masahiro KATAOKA, Naruto-shi (JP)

(21) Appl. No.: 19/358,421

(22) Filed: Oct. 15, 2025

(30) Foreign Application Priority Data
Oct. 21, 2024 (JP) 2024-185395

(51) Int. Cl. H02J 7/00

(52) U.S. Cl. CPC H02J 7/40; H02J 7/50; H02J 7/82; H02J 7/84

(57) ABSTRACT

An electricity storage apparatus includes electricity storage devices, low-order controllers, a high-order controller, communication lines, and signal lines. The low-order controllers and the high-order controller are cyclically connected in a preset order of connection via the signal lines. The high-order controller outputs a pulse signal with a preset pulse width to the low-order control set to a smallest connection order of the order of connection via a corresponding one of the signal lines. The low-order controller outputs a pulse signal with a preset pulse width different from that of the pulse signal that has been input thereto to a downstream side in the order of connection via a corresponding one of the signal line.

### CROSS REFERENCE OF RELATED APPLICATION

This application claims the benefit of priority to Japanese Patent Application No. 2024-185395 filed on Oct. 21, 2024. The entire contents of this application are hereby incorporated herein by reference.

### BACKGROUND

The present disclosure relates to an electricity storage apparatus.

International Patent Publication No. WO2012/131797 discloses a communication system including a master device including a communication function and first to Nth multiple slave devices each including a communication function. The master device and the multiple slave devices are connected via communication lines. The master device outputs an Nth ID setting signal that instructs the Nth slave device to set an identifier. Thus, the Nth slave device is instructed to perform ID setting. The master device transmits an identifier “N” to the Nth slave device. The ID “N” is set to the Nth slave device. The Nth slave device transmits an ID setting completion notification to the master device.

Upon receiving the ID setting completion notification from the Nth slave device, the master device instructs the Nth slave device to output an (N−1)th ID setting signal. The Nth slave device outputs the (N−1)th ID setting signal. The (N−1)th ID setting signal is given to the (N−1)th slave device. Thus, the (N−1)th slave device is instructed to set an ID. The master device transmits an identifier ID “N−1” to the (N−1)th slave device. An ID “N−1” is set to the (N−1)th slave device. The (N−1)th slave device transmits an ID setting completion notification to the master device. Processing described above is repeated until an ID “1” is set to the first slave device. When ID setting of all the first to Nth slave devices is completed, the master device transmits an ID setting processing end notification to the first to Nth slave devices.

As described above, in the communication system disclosed in International Patent Publication No. WO2012/131797, IDs are set to the first to Nth slave devices in an order from the Nth slave device to the first slave device. Herein, the master device instructs, after completion of ID setting for the slave device is confirmed, the slave device to output an ID setting signal to a next slave device. Thereafter, the master device transmits an identifier of ID to the next slave device.

### SUMMARY

The present inventors desire to reduce, in an electricity storage apparatus in which multiple electricity storage devices are incorporated, a time required for ID setting of controllers each of which controls a corresponding one of the electricity storage devices.

An electricity storage apparatus disclosed herein includes N electricity storage devices, N low-order controllers, a high-order controller, N communication lines, and (N+1) signal lines. Each of the N low-order controllers controls a corresponding one of the N electricity storage devices. The high-order controller is connected to the N low-order controllers. Each of the N low-order controllers is connected to the high-order controller via a corresponding one of the communication lines. The N low-order controllers and the high-order controller are cyclically connected in a preset order of connection via the signal lines. The high-order controller is configured to cause execution of processing of instructing ID setting and processing of outputting a pulse signal. In the processing of instructing ID setting, the high-order controller instructs each of the N low-order controllers to perform ID setting via a corresponding one of the communication lines. In the processing of outputting a pulse signal, the high-order controller outputs a pulse signal with a preset pulse width to the low-order control set to a smallest connection order of the order of connection via a corresponding one of the signal lines. Each of the N low-order controllers stores information in which a corresponding one of different IDs of 1 to N and a pulse signal with a corresponding one of different pulse widths in accordance with the IDs of 1 to N correspond to each other. Each of the N low-order controllers is configured to cause execution of processing of inputting a pulse signal, processing of determining an ID of the N low-order controller itself, and processing of outputting a pulse signal. In the processing of inputting a pulse signal, the low-order controller inputs a pulse signal from an upstream side in the order of connection via a corresponding one of the signal lines. In the processing of determining an ID of the N low-order controller itself, the low-order controller determines the ID of the N low-order controller itself, based on the pulse width of the pulse signal that is input thereto and the information. In the processing of outputting a pulse signal, the low-order controller outputs a pulse signal with a preset pulse width different from that of the pulse signal that has been input thereto to a downstream side in the order of connection via a corresponding one of the signal line. In the electricity storage apparatus described above, a time required for ID setting is reduced.

### BRIEF DESCRIPTION OF THE DRAWINGS

FIG. 1 is a schematic view of an electricity storage apparatus 100.

FIG. 2 is a sequence diagram during ID setting.

FIG. 3 is a flowchart of processing executed in the high-order controller 10 during ID setting.

FIG. 4 is a flowchart of processing executed in the low-order controller 20 during ID setting.

FIG. 5 is a flowchart of processing executed in the low-order controller 30 during ID setting.

FIG. 6 is a flowchart of processing that is executed in the high-order controller 10 after ID setting is completed.

FIG. 7 is a flowchart of processing that is executed in the low-order controller 20 after ID setting is completed.

FIG. 8 is a flowchart of processing that is executed in the low-order controller 30 after ID setting is completed.

### DETAILED DESCRIPTION OF THE EMBODIMENTS

Embodiments of a technology disclosed herein will be described below with reference to the accompanying drawings. As a matter of course, the embodiments described herein are not intended to be particularly limiting the present disclosure. The accompanying drawings are schematic and do not necessarily reflect actual members or portions. Members/portions that have the same effect will be denoted by the same sign as appropriate, and the overlapping description will be omitted as appropriate.

### <Electricity Storage Apparatus 100>

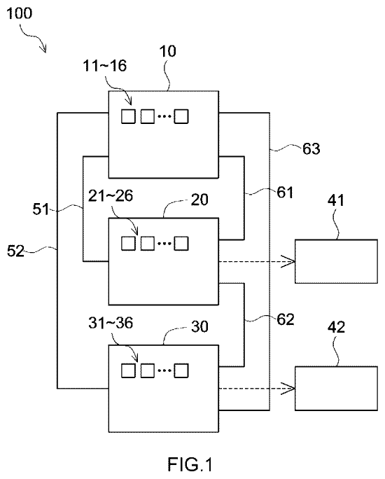

FIG. 1 is a schematic view of an electricity storage apparatus 100. As illustrated in FIG. 1, the electricity storage apparatus 100 includes two electricity storage devices 41 and 42, two low-order controllers 20 and 30, a high-order controller 10, two communication lines 51 and 52, and three signal lines 61 to 63.

The electricity storage apparatus 100 supplies electric power stored in the electricity storage devices 41 and 42 to a load (for example, a vehicle driving device, such as an electric motor device or the like) or the like. The electricity storage devices 41 and 42 can be connected to a load, an external power source, or the like that is not illustrated in the drawings. The low-order controllers 20 and 30 are controllers that controls the electricity storage devices 41 and 42. The high-order controller 10 performs control to cause the multiple electricity storage devices 41 and 42 incorporated in the electricity storage apparatus 100 to cooperate. The high-order controller 10 may be communicably connected to the external controller (for example, an in-vehicle electronic control unit (ECU)).

### <Electricity Storage Devices 41 and 42>

The electricity storage devices 41 and 42 are devices that can be repeatedly charged and discharged. Each of the electricity storage devices 41 and 42 can be a module in which a preset number of cells are connected by a bus bar and are arranged. Each of the electricity storage devices 41 and 42 can be configured of multiple cells connected in series. The cells encompass secondary batteries, such as lithium-ion secondary batteries, nickel-hydrogen batteries, or the like. The cells encompass capacitors, such as lithium-ion capacitors, electrical double-layer capacitors, or the like. An electrolytic solution may be used for the cells, and a solid electrolyte may be used for the cells. For example, the cells may be secondary batteries in which a so-called liquid electrolytic solution is used, and may be so-called all-solid batteries in which a solid electrolyte is used. The electricity storage devices 41 and 42 are individually controlled by the low-order controllers 20 and 30, respectively.

### <Low-Order Controllers 20 and 30>

The low-order controllers 20 and 30 control the electricity storage devices 41 and 42, respectively. The low-order controller 20 is connected to the electricity storage device 41 and controls charge and discharge or the like of the electricity storage device 41. The low-order controller 30 is connected to the electricity storage device 42 and controls charge and discharge or the like of the electricity storage device 42. The low-order controllers 20 and 30 are connected to an unillustrated sensor (a voltage sensor, an electric current sensor, a temperature sensor, or the like) or the like. Each of the low-order controllers 20 and 30 can calculate a state of charge (SOC) of a cell, based on a detection value detected by the sensor. The low-order controllers 20 and 30 can execute various types of arithmetic processing, determination processing, or the like to control charge and discharge of the electricity storage devices 41 and 42.

The low-order controllers 20 and 30 are connected to the high-order controller 10 via the communication lines 51 and 52, respectively. The communication line 51 connects the high-order controller 10 and the low-order controller 20. The communication line 52 connects the high-order controller 10 and the low-order controller 30. A communicator 12 of the high-order controller 10 and a communicator 22 of the low-order controller 20 are configured to be communicable with each other via the communication line 51. The communicator 12 of the high-order controller 10 and a communicator 32 of the low-order controller 30 are configured to be communicable with each other via the communication line 52. The low-order controllers 20 and 30 and the high-order controller 10 are configured to be communicable with each other, for example, through a controller area network (CAN) communication. The low-order controllers 20 and 30 control the electricity storage devices 41 and 42, respectively, in accordance with an instruction from the high-order controller 10.

### <High-Order Controller 10>

The high-order controller 10 is connected to the low-order controllers 20 and 30. The high-order controller 10 can determine whether there is an abnormality of the electricity storage devices 41 and 42 or the like, based on processing executed by the low-order controllers 20 and 30 and control charge and discharge of the electricity storage device 41 and electricity storage device 42. For example, the high-order controller 10 may be configured to monitor an abnormality in the cells of the electricity storage devices 41 and 42, based on a result of various types of arithmetic processing, determination processing, or the like of the low-order controllers 20 and 30. When the high-order controller 10 detects an abnormality in any one of the cells, the high-order controller 10 can instruct the low-order controllers 20 and 30 to stop charge and discharge of the electricity device including the cell.

The high-order controller 10 is cyclically connected to the low-order controllers 20 and 30 via the signal lines 61 to 63 in a preset order of connection. In other words, the low-order controllers 20 and 30 and the high-order controller 10 are connected in a loop via the signal lines 61 to 63. In the electricity storage apparatus 100, the low-order controllers 20 and 30 and the high-order controller 10 are connected such that each of the low-order controllers 20 and 30 and the high-order controller 10 is connected to corresponding two of the signal lines 61 to 63. In this embodiment, the order of connection is set to an order of the high-order controller 10, the low-order controller 20, and the low-order controller 30, and the low-order controller 30 that is last in the order of connection is connected to the high-order controller 10.

Herein, the high-order controller 10 and the low-order controller 20 are connected via the signal line 61. The low-order controller 20 and the low-order controller 30 are connected via the signal line 62. The low-order controller 30 and the high-order controller 10 are connected via the signal line 63. Each of the signal lines 61 to 63 is used for transmission and reception of a pulse signal. In other words, the high-order controller 10 and the low-order controllers 20 and 30 transmit and receive the pulse signal via the signal lines 61 to 63. The low-order controllers 20 and 30 are configured such that a pulse signal is input thereto from an upstream side in the order of connection via the signal lines 61 and 62. The high-order controller 10 is configured such that a pulse signal is input thereto from the low-order controller that is last in the order of connection via the signal line 63.

Incidentally, in order to properly control the electricity storage devices 41 and 42, it is necessary that communications between the low-order controllers 20 and 30 connected to the electricity storage devices 41 and 42 and the high-order controller 10 are established. The low-order controllers 20 and 30 IDs of which are preset need to be identified by the high-order controller 10. Processing of setting an ID to each of the low-order controllers 20 and 30 and establishing communications between the high-order controller 10 and the low-order controllers 20 and 30 will be described below.

An ID that is to be set to each of the low-order controllers 20 and 30 is preset. The low-order controller 20 needs to be set to an ID “1.” The low-order controller 30 needs to be set to an ID “2.” The high-order controller 10 needs to be configured to be communicable with the low-order controller 20 with the ID “1” via the communication line 51 and needs to be configured to be communicable with the low-order controller 30 with the ID “2” via the communication line 52. When something is wrong in ID setting (for example, when the low-order controller 20 is set to the ID “2” and the low-order controller 30 is set to the ID “1”), a system including the electricity storage apparatus 100 has an abnormality. In this case, control or the like for safety is not performed and the abnormality of the system is immediately reported to a vehicle on which the electrode sheet 1 is mounted, an administrator, or the like.

In this embodiment, ID setting is performed at start of the electricity storage apparatus 100. Note that there is no particular limitation on a timing of ID setting. The high-order controller 10 includes a storage 11, a communicator 12, a determinator 13, an ID setting instructor 14, a pulse inputter 15, and a pulse outputter 16. The low-order controller 20 includes a storge 21, a communicator 22, a determinator 23, an ID determinator 24, a pulse inputter 25, and a pulse outputter 26. The low-order controller 30 includes a storge 31, a communicator 32, a determinator 33, an ID determinator 34, a pulse inputter 35, and a pulse outputter 36. Each of the sections of the high-order controller 10 and the low-order controllers 20 and 30 may be realized by one or more processors and may be incorporated in a circuit.

ID setting can be performed based on the pulse signal that is transmitted and received between the controllers. The pulse outputter 16 of the high-order controller 10 is configured to output a signal with a pulse width indicted in Table 1. The pulse outputter 16 outputs the pulse signal at all times during ID setting. Herein, the pulse outputter 16 outputs the pulse signal to the low-order controller (the low-order controller connected thereto via the signal line 61) set to a smallest connection order in the preset order of connection via the signal line 61. A signal with a pulse width output by the last low-order controller (in this embodiment, the low-order controller 30) that is cyclically connected is input to the pulse inputter 15 of the high-order controller 10. The high-order controller 10 stores the pulse width (in this embodiment, 30 ms) that is to be input from the last low-order controller in advance.

Each of the low-order controllers 20 and 30 stores information in which an ID that is to be set and a pulse signal with a corresponding one of different pulse widths in accordance with the ID correspond to each other. Each of the pulse outputters 26 and 36 of low-order controllers 20 and 30 is configured to output a signal with a pulse width indicated in Table 1 and corresponds to the ID thereof. The pulse widths are different from each other in accordance with the IDs. In this embodiment, to make it easy to understand a relationship between each ID and a corresponding pulse width, the relationship of the ID and the pulse signal is determined such that the larger the ID is, the larger the pulse width becomes. Each of the ID determinators 24 and 34 of the low-order controllers 20 and 30 determines an ID indicated in Table 1 as the ID of a corresponding one of the low-order controllers 20 and 30 itself when a signal with a corresponding one of the pulse widths indicated in Table 1 is input to a corresponding one of the pulse inputters 25 and 35. The pulse width of the pulse signal output by each controller and the pulse width of the pulse signal input to each controller may be stored in a corresponding one of the storages 11, 21, and 31 of the controllers.

TABLE 1

| ID | ID | Output (ms) | Input (ms) |
|---|---|---|---|
| High-order controller 10 | — | 10 | Output value of last |
| | | | low-order controller |
| Low-order controller 20 | 1 | 20 | 10 |
| Low-order controller 30 | 2 | 30 | 20 |

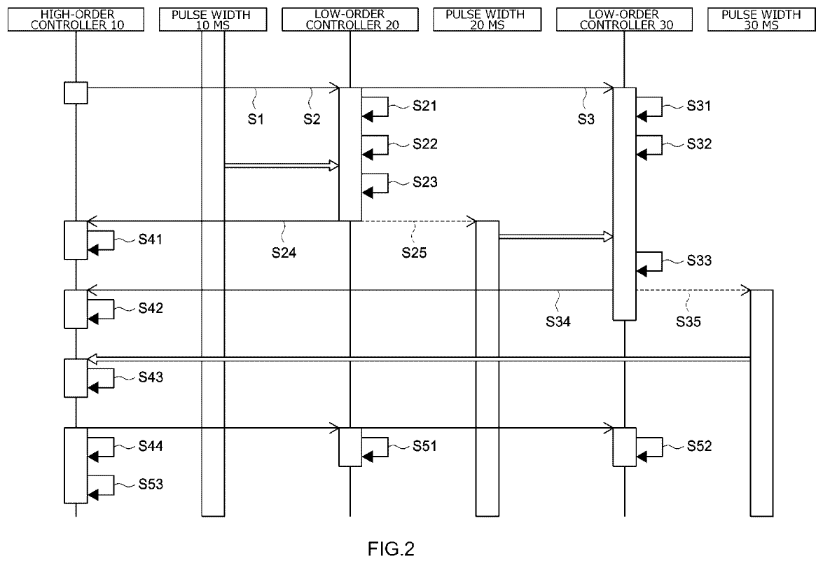

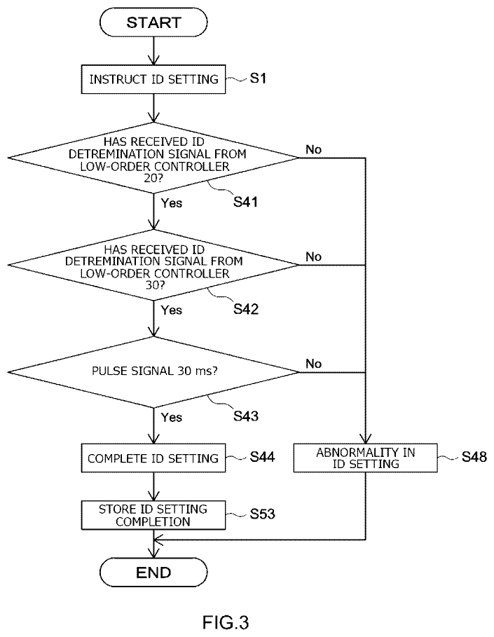

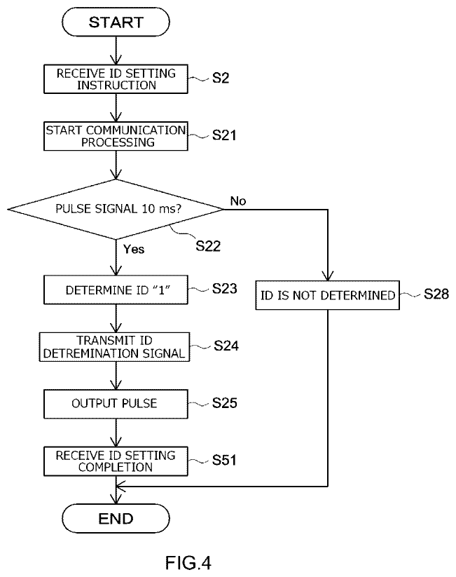

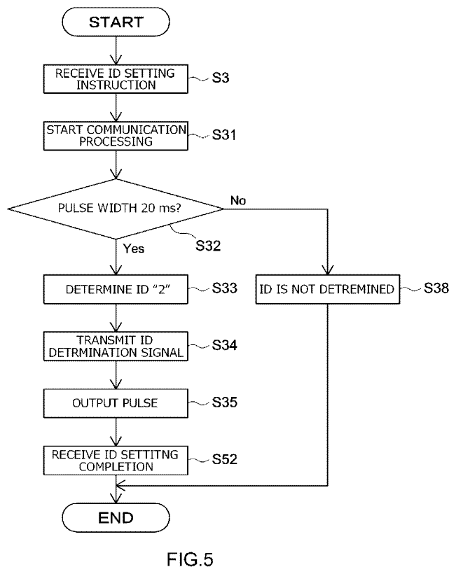

FIG. 2 is a sequence diagram during ID setting. FIG. 3 is a flowchart of processing executed in the high-order controller 10 during ID setting. FIG. 4 is a flowchart of processing executed in the low-order controller 20 during ID setting. FIG. 5 is a flowchart of processing executed in the low-order controller 30 during ID setting.

At a start of the electricity storage apparatus 100, when ID setting is started, in Step S1 (see FIG. 2 and FIG. 3), the ID setting instructor 14 of the high-order controller 10 instructs each of the low-order controllers 20 and 30 to perform ID setting via the communication lines 51 and 52. Herein, setting of IDs in accordance with the number of low-order controllers is instructed. In this embodiment, an ID of either “1” or “2” is set to each of the low-order controllers 20 and 30. In Step S2 (see FIG. 2 and FIG. 4), the communicator 22 of the low-order controller 20 receives an instruction of ID setting via the communication line 51. In Step S3 (see FIG. 2 and FIG. 5), the communicator 32 of the low-order controller 30 receives an instruction of ID setting via the communication line 52.

In Step S21 (see FIG. 2 and FIG. 4), the communicator 22 of the low-order controller 20 starts communication processing with the high-order controller 10 via the communication line 51. In Step S31 (see FIG. 2 and FIG. 5), the communicator 32 of the low-order controller 30 starts communication processing with the high-order controller 10 via the communication line 52.

Processing that is executed by the low-order controller 20 after communication processing with the high-order controller 10 is started (Step S21) will be described with reference to FIG. 2 and FIG. 4. In Step S22, a pulse signal can be input to the pulse inputter 25.

During ID setting, the pulse outputter 16 of the high-order controller 10 outputs a pulse signal at all times. When the low-order controller 20 is connected in a wrong order or the like, a pulse signal a pulse width of which is not 10 ms can be input to the pulse inputter 25. As another case, a pulse signal is not input to the pulse inputter 25. When the low-order controller 20 and the high-order controller 10 are connected in a correct order via the signal line 61, a pulse signal with a pulse width of 10 ms is input to the pulse inputter 25.

The low-order controller 20 determines an ID of the low-order controller 20 itself, based on the pulse width of the pulse signal that is input and the pulse width corresponding to the ID (see Table 1) that is to be set. In Step S22, the determinator 23 determines whether the pulse width of the pulse signal that has been input is 10 ms. When the pulse width is not 10 ms (No), the process proceeds to Step S28 and the ID is not determined. At this time, an ID determination signal to the high-order controller 10 from the low-order controller 20 via the communication line 51 is not transmitted.

When the pulse width of the pulse signal that is input in Step S22 is 10 ms (Yes), the process proceeds to Step S23. In Step S23, the ID determinator 24 determines “1” as the ID of the low-order controller 20 and stores the ID in the storge 21. After the ID of the low-order controller 20 is determined, in Step S24, the communicator 22 transmits an ID determination signal indicating that the ID has been determined to the high-order controller 10 via the communication line 51. Thus, the high-order controller 10 and the low-order controller 20 establish a two-way communication. After the signal is transmitted, in Step S25, the pulse outputter 26 starts outputting a pulse signal with a different pulse width from the pulse width of the pulse signal that has been input thereto. The pulse outputter 26 outputs a pulse signal with the pulse width of 20 ms via the signal line 62.

Subsequently, processing that is executed by the low-order controller 30 after communication processing with the high-order controller 10 is started (Step S31) will be described with reference to FIG. 2 and FIG. 5. In Step S32, a pulse signal can be input to the pulse inputter 35.

During ID setting, when the ID of the low-order controller 20 is properly set, a pulse signal with a pulse width of 20 ms is output from the pulse outputter 26 of the low-order controller 20. When at least one of the low-order controllers 20 and 30 is connected in a wrong order or the like, a pulse signal a pulse width of which is not 20 ms can be input to the pulse inputter 35. As another case, a pulse signal is not input to the pulse inputter 35. When the low-order controller 20 and the low-order controller 30 are connected in a correct order via the signal line 62, a pulse signal with a pulse width of 20 ms is input to the pulse inputter 35.

The low-order controller 30 determines an ID of the low-order controller 30 itself, based on the pulse width of the pulse signal that is input and the pulse width corresponding to the ID (see Table 1) that is to be set. In Step S32, the determinator 33 determines whether the pulse width of the pulse signal that is input is 20 ms. When the pulse width is not 20 ms (No), the process proceeds to Step S38 and the ID is not determined. At this time, an ID determination signal to the high-order controller 10 from the low-order controller 30 via the communication line 52 is not transmitted.

In Step S32, when the pulse width of the pulse signal that is input is 20 ms (Yes), the process proceeds to Step S33. In Step S33, the ID determinator 34 determines “2” as the ID of the low-order controller 30 and stores the ID in the storge 31. After the ID of the low-order controller 30 is determined, in Step S34, the communicator 32 transmits an ID determination signal indicating that the ID has been determined to the high-order controller 10 via the communication line 52. Thus, the high-order controller 10 and the low-order controller 30 establish a two-way communication. After the signal is transmitted, in Step S35, the pulse outputter 36 starts outputting a pulse signal with a different pulse width from the pulse width of the pulse signal that has been input thereto. The pulse outputter 36 outputs a pulse signal with a pulse width of 30 ms via the signal line 63.

Subsequently, processing that is executed by the high-order controller 10 after instructing ID setting will be described with reference to FIG. 2 and FIG. 3. After instructing ID setting, the high-order controller 10 stands by for receiving ID determination signals transmitted from the low-order controllers 20 and 30.

In Step S41, the determinator 13 of the high-order controller 10 determines whether the high-order controller 10 has received the ID determination signal from the low-order controller 20. When the high-order controller 10 has not received the ID determination signal from the low-order controller 20 for a preset time since the high-order controller 10 instructed ID setting in Step S1 (No), the process proceeds to Step S48. In Step S48, the determinator 13 determines that an abnormality has occurred in ID setting and processing ends without an ID being set. The high-order controller 10 can store that the abnormality has occurred. In addition, the high-order controller 10 can recognize that the abnormality occurred during ID setting and report occurrence of the abnormality to the administrator of the electricity storage apparatus 100, the vehicle on which the electricity storage apparatus 100 is mounted, or the like. When the determinator 13 determines that the high-order controller 10 has received the ID determination signal from the low-order controller 20 (Yes), the process proceeds to Step S42.

In Step S42, the determinator 13 of the high-order controller 10 determines whether the high-order controller 10 has received the ID determination signal from the low-order controller 30. When the high-order controller 10 has not received the ID determination signal from the low-order controller 30 for a preset time since the high-order controller 10 instructed ID setting (or determination was made in Step S41) (No), the process proceeds to Step S48. When the determinator 13 determines that the high-order controller 10 has received the ID determination signal from the low-order controller 30 (Yes), the process proceeds to Step S43. In Step S43, a pulse signal can be input to the pulse inputter 15 of the high-order controller 10.

During ID setting, when the ID of the low-order controller 30 is properly set, a pulse signal with a pulse width of 30 ms is output from the pulse outputter 36 of the low-order controller 30. When the low-order controller 30 is connected in a wrong order or the like, a pulse signal with a pulse width of which is not 30 ms can be input to the pulse inputter 15. As another case, a pulse signal is not input to the pulse inputter 15. When the high-order controller 10 and the low-order controller 30 are connected in a correct order via the signal line 63, a pulse signal with a pulse width of 30 ms is input to the pulse inputter 15.

In Step S43, the determinator 13 determines whether a pulse width of a pulse signal that is input thereto is 30 ms. When the pulse width is not 30 ms (No), the process proceeds to Step S48 described above. In Step S43, when the pulse width of the pulse signal that is input thereto is 30 ms (Yes), the process proceeds to Step S44.

In Step S44, the communicator 12 of the high-order controller 10 transmits a signal indicating that the high-order controller 10 and the low-order controllers 20 and 30 are properly connected and ID setting is completed to the low-order controllers 20 and 30 via the communication lines 51 and 52. In Step S51 (see FIG. 2 and FIG. 4), the low-order controller 20 that has received the signal indicating that ID setting is completed terminates determination processing for the pulse signal (Step S22). In Step S52 (see FIG. 2 and FIG. 5), the low-order controller 30 that has received the signal indicating that ID setting is completed terminates determination processing for the pulse signal (Step S32). In Step S53 (see FIG. 2 and FIG. 3), the storage 11 of the high-order controller 10 stores that ID setting is completed. Thereafter, ID setting processing by the high-order controller 10 and the low-order controllers 20 and 30 ends.

In the embodiment described above, the two low-order controllers 20 and 30 are connected to the high-order controller 10 via the communication lines 51 and 52, respectively. The two low-order controllers 20 and 30 and the high-order controller 10 are cyclically connected in a preset order of connection via the signal lines 61 to 63. The high-order controller 10 is configured to cause execution of processing of instructing ID setting and processing of outputting a pulse signal. The high-order controller 10 instructs each of the two low-order controllers 20 and 30 to perform ID setting via the communication lines 51 and 52 in the processing of instructing ID setting. The high-order controller 10 outputs a pulse signal with a preset pulse width (in this embodiment, 10 ms) to the low-order controller 20 that has been set in a smallest connection order in of the order of connection via the signal line 61. Each of the two low-order controllers 20 and 30 stores information in which a corresponding one of the ID “1” and the ID “2” and a pulse signal with a corresponding one of different pulse widths corresponding to the IDs “1” and “2” correspond to each other. Each of the two low-order controllers 20 and 30 is configured to cause execution of processing of inputting a pulse signal, processing of determining the ID of a corresponding one of the low-order controllers 20 and 30 itself, and processing of outputting the pulse signal. In the processing of inputting a pulse signal, each of the low-order controllers 20 and 30 inputs the pulse signal output from an upstream side in the order of connection via a corresponding one of the signal lines 61 and 62. Each of the low-order controllers 20 and 30 determines the ID of a corresponding one of the low-order controllers 20 and 30 itself, based on the pulse width of the pulse signal that is input thereto and the information described above in the processing of determining the ID of the corresponding one of the low-order controllers 20 and 30 itself. Each of the low-order controllers 20 and 30 outputs a pulse signal with a preset pulse signal that is different from that of the pulse signal that has been input thereto to a downstream side in the order of connection via a corresponding one of the signal lines 62 and 63 in the processing of outputting a pulse signal.

In the electricity storage apparatus 100 described above, the high-order controller 10 outputs the pulse signal to the low-order controller 20. The high-order controller 10 only outputs, during ID determination, the pulse signal for ID determination to the low-order controller 20 in the smallest connection order such that the IDs of both the low-order controllers 20 and 30 are sequentially determined. The high-order controller 10 does not need to output the pulse signal for ID determination to the low-order controller (in this embodiment, the low-order controller 30) other than the low-order controller 20 that is in the smallest connection order. In other words, the high-order controller 10 only needs to transmit the signal only to the low-order controller 20 and does not need to transmit the signal for ID determination to all the low-order controllers. Therefore, the number of times of communications performed between the high-order controller 10 and the low-order controllers 20 and 30 that are needed for ID setting can be reduced. As a result, ID setting to the low-order controllers 20 and 30 can be completed early.

In the embodiment described above, each of the two low-order controllers 20 and 30 transmits, after determining the ID of a corresponding one of the low-order controllers 20 and 30 itself, the ID determination signal to the high-order controller 10 via a corresponding one of the communication lines 51 and 52 to establish a two-way communication with the high-order controller 10. Since a two-way communication is established only with the low-order controllers 20 and 30 the IDs of which have been determined, an inconvenience is less likely to occur in the communications between the high-order controller 10 and the low-order controllers 20 and 30. As a result, a safety level of the electricity storage apparatus 100 can be increased.

In the embodiment described above, the high-order controller 10 completes ID setting when the high-order controller 10 receives the ID determination signals from all the low-order controllers 20 and 30. Thus, communications between the high-order controller 10 and the low-order controllers 20 and 30 can be more reliably established.

In the embodiment described above, ID setting is completed based on the pulse width of the pulse signal that is output from the last low-order controller (in this embodiment, the low-order controller 30) that is last in the order of connection. Therefore, it is reliably detected that the IDs have been properly set in the high-order controller 10 and the low-order controllers 20 and 30.

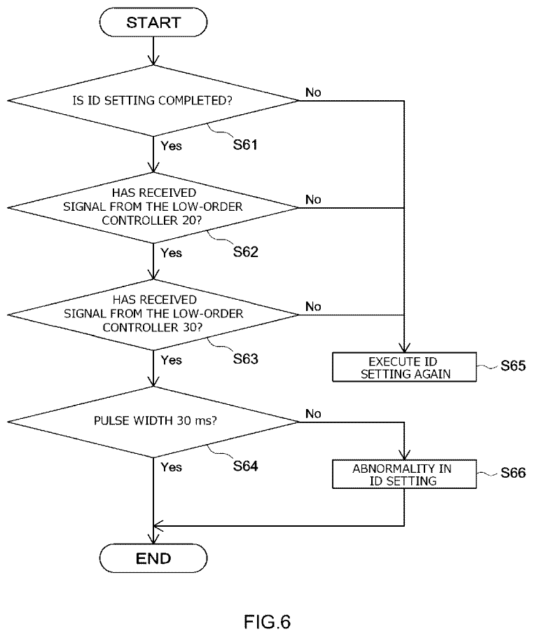

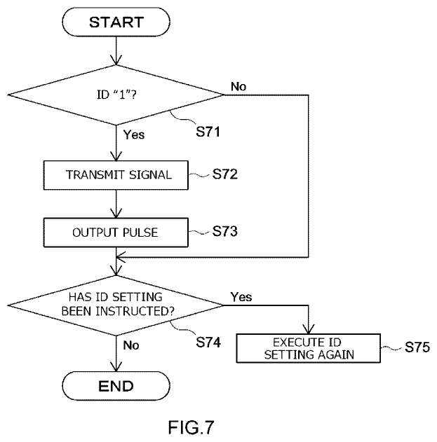

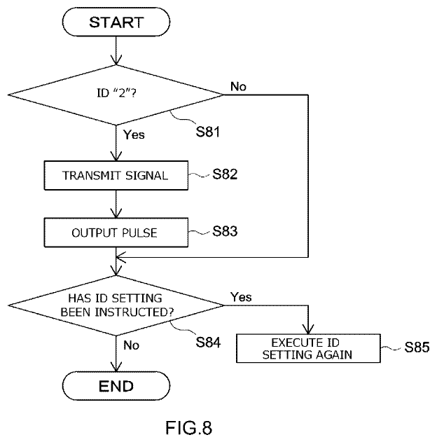

Processing performed during setting of the IDs of the high-order controller 10 and the low-order controllers 20 and 30 has been described above. In the electricity storage apparatus 100, also after ID setting is completed, whether the IDs have been properly set can be confirmed at a start of the electricity storage apparatus 100. FIG. 6 is a flowchart of processing that is executed in the high-order controller 10 after ID setting is completed. FIG. 7 is a flowchart of processing that is executed in the low-order controller 20 after ID setting is completed. FIG. 8 is a flowchart of processing that is executed in the low-order controller 30 after ID setting is completed.

At a start of the electricity storage apparatus 100, whether the IDs of the low-order controllers 20 and 30 have been set may be determined. The high-order controller 10 determines whether ID setting is completed in Step S61 (see FIG. 6). The determinator 13 determines whether the storage 11 stores that ID setting is completed. When the storage 11 does not store that ID setting is completed (No), the process proceeds to Step S65. In Step S65, ID setting processing described above is re-executed. In Step S65, the ID setting instructor 14 instructs each of the low-order controllers 20 and 30 to perform ID setting. In the high-order controller 10, processing illustrated in FIG. 2 and FIG. 3 is executed.

In the low-order controller 20, whether the ID of the low-order controller 20 itself has been set may be determined. In the low-order controller 20, in Step S71 (see FIG. 7), the determinator 23 determines whether the ID “1” is stored in the storge 21. When the ID “1” is not stored in the storge 21 (No), the process proceeds to Step S74. When the ID “1” is stored in the storge 21 (Yes), the process proceeds to Step S72. In Step S72, the low-order controller 20 transmits a signal to the high-order controller 10 via the communication line 51. In the Step S73, the low-order controller 20 starts outputting a pulse signal with a pulse width (20 ms) in accordance with the ID “1.” In Step S74, the determinator 23 determines whether an ID setting instruction has been transmitted thereto from the high-order controller 10. In Step S65 (see FIG. 6), when the ID setting instruction has been transmitted thereto (Yes), in the low-order controller 20, processing indicated in FIG. 2 and FIG. 4 described above is executed. When the ID setting instruction has not been transmitted thereto from the high-order controller 10 for a preset time (No), in the low-order controller 20, processing of confirming ID setting ends.

Similar to the low-order controller 20, in the low-order controller 30, whether the ID of the low-order controller 30 itself has been set may be determined. In the low-order controller 30, in Step S81 (see FIG. 8), the determinator 33 determines whether the ID “2” is stored in the storge 31. When the ID “2” is not stored in the storge 31 (No), the process proceeds to Step S84. When the ID “2” is stored in the storge 31 (Yes), the process proceeds to Step S82. In Step S82, the low-order controller 30 transmits a signal to the high-order controller 10 via the communication line 52. In Step S83, the low-order controller 30 starts outputting a pulse signal with a pulse width (30 ms) in accordance with the ID “2.” In Step S84, the determinator 33 determines whether the ID setting instruction has been transmitted thereto from the high-order controller 10. When the ID setting has been transmitted thereto in Step S65 (see FIG. 6) (Yes), in the low-order controller 30, processing indicated in FIG. 2 and FIG. 5 described above is executed. When the ID setting instruction has not been transmitted thereto from the high-order controller 10 for a preset time (No), in the low-order controller 30, processing of confirming ID setting ends.

In the high-order controller 10, in Step S61 (see FIG. 6), when the storage 11 stores that the ID setting is completed (Yes), the process proceeds to Step S62. In Step S62, the high-order controller 10 confirms whether the ID of the low-order controller 20 has been set. In Step S62, the determinator 13 confirms whether the high-order controller 10 has received a signal from the low-order controller 20 via the communication line 51. When the high-order controller 10 has not received the signal from the low-order controller 20 for a preset time (No), the process proceeds to Step S65. When the high-order controller 10 has received the signal from the low-order controller 20 (Yes), the process proceeds to Step S63. In Step S63, the high-order controller 10 confirms whether the ID of the low-order controller 30 has been set. In Step S63, the determinator 13 confirms whether the high-order controller 10 has received a signal from the low-order controller 30 via the communication line 52. When the high-order controller 10 has not received the signal for a preset time (No), the process proceeds to Step S65 described above. When the high-order controller 10 has received the signal from the low-order controller 30 (Yes), the process proceeds to Step S64.

In Step S64, the high-order controller 10 confirms a pulse width of a pulse signal that is input to the high-order controller 10 via the signal line 63. In Step S64, the determinator 13 determines whether the pulse width of the pulse signal that is input is a pulse width (30 ms) that is to be output from the low-order controller 30 that is in a last communication order. When the pulse width of the pulse signal that is input via the signal line 63 is 30 ms (Yes), in the high-order controller 10, processing of confirming ID setting ends. When the pulse width of the pulse signal that is input via the signal line 63 is not 30 ms (No), it can be determined that an abnormality occurred in the order of the low-order controllers 20 and 30 or the like. In Step S66, the high-order controller 10 can recognize that the abnormality occurred during ID setting and report occurrence of the abnormality to the administrator of the electricity storage apparatus 100 or the like.

In the embodiment described above, the number of low-order controllers is two, but the number of low-order controllers may be three or more. When each of multiple low-order controllers is connected to a high-order controller via a corresponding one of communication lines and the high-order controller and the multiple low-order controllers are cyclically connected in a preset order of communication via the signal lines, regardless of the number of the low-order controllers, the processing described above can be executed.

In the embodiment described above, a pulse width of a pulse signal is set such that the larger the order of connection number is, the longer the pulse width becomes. However, the pulse signal and the pulse width are not limited thereto. The pulse widths of the pulse signals that is transmitted and received by the high-order controller and the low-order controllers may be different from each other in accordance with the order of connection.

The technology disclosed herein has been described above in various forms.

However, the embodiments described above or the like shall not limit the present disclosure, unless specifically stated otherwise. Various changes can be made to the technology disclosed herein, and each of components and processes described herein can be omitted as appropriate or can be combined with another one or other ones of the components and the processes as appropriate, unless a particular problem occurs. The present specification includes disclosure set forth in the following items.

First Item: An electricity storage apparatus including N electricity storage devices, N low-order controllers each of which controls a corresponding one of the N electricity storage devices, a high-order controller connected to the N low-order controllers, N communication lines, and (N+1) signal lines, in which each of the N low-order controllers is connected to the high-order controller via a corresponding one of the communication lines, the N low-order controllers and the high-order controller are cyclically connected in a preset order of connection via the signal lines, the high-order controller is configured to cause execution of processing of instructing each of the N low-order controllers to perform ID setting via a corresponding one of the communication lines, and processing of outputting a pulse signal with a preset pulse width to the low-order control set to a smallest connection order of the order of connection via a corresponding one of the signal lines, each of the N low-order controllers stores information in which a corresponding one of different IDs of 1 to N and a pulse signal with a corresponding one of different pulse widths in accordance with the IDs of 1 to N correspond to each other, each of the N low-order controllers is configured to cause execution of processing of inputting a pulse signal from an upstream side in the order of connection via a corresponding one of the signal lines, processing of determining an ID of the N low-order controller itself, based on the pulse width of the pulse signal that is input thereto and the information, and processing of outputting a pulse signal with a preset pulse width different from that of the pulse signal that has been input thereto to a downstream side in the order of connection via a corresponding one of the signal line.

Second Item: The electricity storage apparatus according to a first item, in which each of the N low-order controllers transmits, after determining the ID of the N low-order controller itself, an ID determination signal to the high-order controller via a corresponding one of the communication lines to establish a two-way communication with the high-order controller.

Third Item: The electricity storage apparatus according to the second item, in which the high-order controller completes the ID setting when the high-order controller receives the ID determination signals from all the N low-order controllers.

Fourth Item: The electricity storage apparatus according to any one of the first to third items, in which the high-order controller completes the ID setting, based on a pulse signal that is output from the low-order controller that is last in the order of connection.

What is claimed is:

1. An electricity storage apparatus comprising:
N electricity storage devices;
N low-order controllers each of which controls a corresponding one of the N electricity storage devices;
a high-order controller connected to the N low-order controllers;
N communication lines; and
(N+1) signal lines,
wherein
each of the N low-order controllers is connected to the high-order controller via a corresponding one of the communication lines,
the N low-order controllers and the high-order controller are cyclically connected in a preset order of connection via the signal lines,
the high-order controller is configured to cause execution of
processing of instructing each of the N low-order controllers to perform ID setting via a corresponding one of the communication lines, and
processing of outputting a pulse signal with a preset pulse width to the low-order control set to a smallest connection order of the order of connection via a corresponding one of the signal lines,
each of the N low-order controllers stores information in which a corresponding one of different IDs of 1 to N and a pulse signal with a corresponding one of different pulse widths in accordance with the IDs of 1 to N correspond to each other,
each of the N low-order controllers is configured to cause execution of
processing of inputting a pulse signal from an upstream side in the order of connection via a corresponding one of the signal lines,
processing of determining an ID of the N low-order controller itself, based on the pulse width of the pulse signal that is input thereto and the information, and
processing of outputting a pulse signal with a preset pulse width different from that of the pulse signal that has been input thereto to a downstream side in the order of connection via a corresponding one of the signal line.

2. The electricity storage apparatus according to claim 1, wherein
each of the N low-order controllers transmits, after determining the ID of the N low-order controller itself, an ID determination signal to the high-order controller via a corresponding one of the communication lines to establish a two-way communication with the high-order controller.

3. The electricity storage apparatus according to claim 2, wherein
the high-order controller completes the ID setting when the high-order controller receives the ID determination signals from all the N low-order controllers.

4. The electricity storage apparatus according to claim 1, wherein
the high-order controller completes the ID setting, based on a pulse signal that is output from the low-order controller that is last in the order of connection.
